(19) United States
(12) Patent Application Publication
(10) Pub. No.: US 2005/0145047 A1
(43) Pub. Date: Jul. 7, 2005

(54) Climatic test chamber system and a method

(76) Inventors: Bjorn Frannhagen, Landskrona (SE); Lars Dalmyr, Malmo (SE)

Correspondence Address: Steven S. Payne;Suite 1005, 1101 17th Street N.W., Washington, DC, 20036, US

(21) Appl. No.: 11/073,181

(22) Filed: Mar. 4, 2005

Related U.S. Application Data
(63) Continuation-in-part of application No. 10/097,561, filed on Mar. 15, 2002.

(30) Foreign Application Priority Data
Sep. 16, 1999 (SE) 9903327-6

(51) Int. Cl. F25B 19/00; G01G 9/00

(52) U.S. Cl. 73/865

(57) ABSTRACT

A climatic test chamber system has a cooling unit, with refrigerating means for cooling a circulatory secondary refrigerant to be stored in a tank unit, and a chamber unit. The chamber unit has a plurality of isolated test chambers. Each test chamber has regulator means for regulating the supply of secondary refrigerant from the tank unit for individually regulating the test temperature in each test chamber according to a set, desired temperature.

This is a continuation-in-part application of application Ser. No. 10/097,561 filed Mar. 15, 2002.

### FIELD OF INVENTION

The present invention relates to a climatic test chamber system comprising a cooling unit and a chamber unit, having a test chamber.

The invention also relates to a method of providing a climatic test of a plurality of items, wherein refrigerating means are provided for refrigerating a secondary refrigerant.

### BACKGROUND OF THE INVENTION

Climatic tests involving extreme limits of high and low temperatures are of great importance for estimating and evaluating the effect of storing, transporting and ageing different kind of items and products, for example electronics, batteries, mobile telephones, electro-mechanical components, plastic components, raw materials, etc.

Previously known climatic test chamber systems for testing such items and products, under controlled temperature conditions, may comprise a single, isolated test chamber, having refrigerating means mounted adjacently to the test chamber. In such test chambers it may be desirable to obtain rapid changes of temperature, which may occur within a broad temperature range, e g from −80° C. to +180° C.

Different systems are known for such climatic tests. For example, an ordinary cooling circuit can be used comprising a condenser, an expansion valve, an evaporator and a compressor, wherein a primary refrigerant circulates for refrigerating the test chamber air. Such a test chamber can further comprise a resistive heating element, which is electrically actuated for heating the air in the test chamber, and a fan for circulating the air for equilibration of temperature. The cooling media for cooling the condenser may be air and the primary refrigerant may be a standard fluid such as R502, R22 or R13. The refrigerating means are activated as soon as a need for a cooling action appears.

A main task for any climatic test chamber system is to regulate the temperature in a controlled way, irrespective if the system is a cooling system or a heating system, or a combination thereof.

U.S. Pat. No. 4,911,230 by Mayer et al discloses a closed system for heating and cooling purposes having a single test chamber. The system uses phase transitions between liquid and vapor of a cooling medium, wherein the physical phenomenon of evaporation (enthalpy) is utilized for cooling. This system is thus dependent on the boiling temperature point of the medium. The cooling medium, referred to as the first fluid heat exchange medium, is used in a circulation loop, which is substantially closed and in which the pressure rises as the test chamber air temperature increases and falls as the test chamber temperature falls. This first fluid medium continuously operates to transfer heat at the boiling temperature of the medium. The idea, according to U.S. Pat. No. 4,911,230 for regulating the temperature in the test chamber, is to float the pressure of the cooling medium with the desired temperature in the test chamber. However, a drawback with this idea is that it can only be used in a system with a single test chamber. If the system had several chambers connected to the circulation loop the result would be that all chambers should affect each other because of different temperature and consequently different boiling pressure. It may be difficult to accurately regulate the individual temperatures of each test chamber. This fact is well known by the skilled man in the art, and may be a reason why there are no climatic systems having multiple test chambers provided on the market based on this idea.

Melgaard et al describes a system in U.S. Pat. No. 4,729,246 comprising a housing having several test stations for mechanical or electrical testing under selected environmental conditions. The products to be tested are moved by a carrier between the stations. The temperature conditions are obtained by using hot air flowing downward on the products. If it is desired to expose the products for temperatures below the ambient temperature, refrigerating coils are actuated. However, the U.S. Pat. No. 4,729,246 does not teach how a fast and regulated temperature control may be obtained; the main part of the patent describes the carrier system.

In spite of a great and accelerated demand for flexible systems for testing components, for example within the telecom and automotive industry, no multiple test chamber systems have been commercialized. This is a clear indication that the engineering problems are significant, and that the solutions are not obvious to a person skilled in the art.

A problem with a single-chamber test system is that it is very time-consuming to finish a test of a complete product or series of similar articles. It is possible to slightly shorten the time if several apparatuses are available, however, a solution that is not satisfactory from an economical point of view.

From the environment point of view, it is important to take into account that several apparatuses would emit a considerably high temperature and produce a high noise-level in the test room. In addition, several apparatuses would be bulky and take up a great deal of room. Furthermore, standard fluids such as R502, R22 or R13 as primary refrigerant are ecologically harmful. If several apparatuses are used, the amount of primary refrigerant will be considerably high.

Another drawback with a single-chamber test system is the stress and hence worn out components, because of the rapid alterations from heating to cooling. Especially the compressor will be negatively affected, since the operation thereof is very irregular depending on continuous starts and stops.

### DISCLOSURE OF THE INVENTION

An object of the present invention is to remedy the drawbacks mentioned above and to provide a climatic test chamber system, which makes it possible to simultaneously perform a plurality of individually regulated climatic tests of different kind of items, such as electronics, batteries, mobile telephones, electromechanical components, plastic components, and raw materials.

Another object of the invention is to provide an economical and improved method for the performance of climatic tests of items of the above-mentioned kind.

There is provided a climatic test chamber system comprising: a tank unit comprising a tank for accumulating a secondary refrigerant at a low temperature at the bottom of the tank; a cooling unit for cooling said secondary refrigerant to at least said low temperature; a circulation unit for circulating said secondary refrigerant from an upper part of said tank, through said cooling unit and to a lower part of said tank; a chamber unit comprising several test chambers for housing objects to be tested, each test chamber having isolation means for heat isolation of each test chamber mutually and separately; and a feeding unit for providing secondary refrigerant from said tank to each of said test chambers individually at demand.

The cooling unit may comprise: a cooling member maintained at a low temperature and having an inlet and an outlet; a first circulation circuit comprising: a pump having an inlet and an outlet; a first line for connecting the outlet of the pump to the inlet of the cooling member; a second line for connecting the outlet of the cooling member to the inlet of the pump; a second circulation circuit comprising: a third line for connecting an inlet of the lower part of the tank to said first circulation circuit at a first connection point; a fourth line for connecting an outlet of the upper part of the tank to said first circulation circuit in a second connection point, which is arranged downstream in relation to said first connection point in said first circulation circuit.

The cooling unit may comprise a third circulation circuit comprising a compressor, an expansion valve, a condenser, an evaporator, and a primary refrigerant circulating in said circuit, wherein said cooling member is said evaporator.

In an embodiment, the pump is controlled by a temperature sensor arranged adjacent the outlet of said cooling member. The pump may have a variable flow. Alternatively, the pump has a constant flow and further comprises a shunt circuit for shunting a variable portion of the constant flow from the outlet of the pump to the inlet of the pump. A shunt valve may be arranged between the outlet and the inlet of the pump for shunting a variable portion of the flow of the pump in dependency of said temperature sensor, for maintaining the secondary refrigerant at the outlet of the cooling member at or below a predetermined temperature.

In another embodiment, a restriction unit may be arranged in said first circulation circuit between said first and second connection point for generating a pressure for driving the secondary refrigerant in said second circulation circuit. The restriction unit may be a three-way valve arranged to pass a portion of the secondary refrigerant from said first circulation circuit and a portion of said secondary refrigerant from said second circulation circuit, the ratio between said portions being adjustable by said valve. Alternatively, a pump may be arranged in said second circulation circuit, said pump being adjustable. The circulation in said second circulation circuit may be controllable so that the secondary refrigerant entering said lower part of said tank has a temperature, which is equal to or lower than a predetermined temperature.

In a further embodiment, each test chamber further comprises a heat exchanger for receiving secondary refrigerant by the feeding unit; and a control valve for controlling the flow of secondary refrigerant through said heat exchanger to obtain a desired temperature of said test chamber. Each test chamber may further comprise: a heating element, such as a resistive heating element, and a fan for equalizing an air temperature in said test chamber.

In a still further embodiment, the feeding unit may further comprise: a pump unit having a pump for feeding said secondary refrigerant from an outlet adjacent the bottom of said tank to each of said heat exchanger of each of said test chambers, said secondary refrigerant being returned to the tank at an inlet thereof adjacent the upper portion of the tank. The pump unit may comprise a shunt valve arranged between an outlet and an inlet of the pump. The shunt valve may be a constant pressure valve for providing a constant pressure over the pump.

The tank may comprise a temperature gradient from the upper to the lower portion of the tank. The temperature gradient may be at least 20° C., such as at least 40° C., such as at least 60° C. The secondary refrigerant may be selected from the group comprising: alcohol, brine and oil.

In a further aspect, there is provided a method of operating a test chamber system, comprising circulating a secondary refrigerant from an upper part of a tank, through a cooling unit and to a lower part of said tank for accumulating cold secondary refrigerant at the bottom portion of said tank; and circulating said secondary refrigerant from the bottom of said tank to each of at least two test chambers individually at demand, said test chambers housing objects to be tested. The method may further comprise: circulating said secondary refrigerant through a first circulation circuit comprising: a pump having an inlet and an outlet; a first line for connecting the outlet of the pump to the inlet of the cooling member; a second line for connecting the outlet of the cooling member to the inlet of the pump; circulating said secondary refrigerant through a second circulation circuit comprising: a third line for connecting an inlet of the lower part of the tank to said first circulation circuit at a first connection point; a fourth line for connecting an outlet of the upper part of the tank to said first circulation circuit in a second connection point, which is arranged downstream in relation to said first connection point in said first circulation circuit. A primary refrigerant may be circulated in a third circulation circuit comprising a compressor, an expansion valve, a condenser, and an evaporator, wherein said cooling member is said evaporator. The circulation in said first circulation circuit may be controlled in dependence of a temperature sensor arranged adjacent the outlet of said cooling member. The circulation in said first circulation circuit may be variable. The circulation in said first circulation circuit may be variable by means of a shunt circuit for shunting a variable portion of a constant flow from the outlet of the pump to the inlet of the pump.

In another embodiment, the method may further comprise: feeding said secondary refrigerant from the second circulation circuit to the first circulation circuit by means of a restriction arranged in said first circulation circuit between said first and second connection point for generating a pressure for driving the secondary refrigerant in said second circulation circuit.

In a further embodiment, the method may further comprise: feeding said secondary refrigerant from the bottom portion of the tank to a heat exchanger of each test chamber to obtain a desired temperature of said test chamber. The method may further comprise energizing a heating element arranged adjacent the test chamber; and activating a fan for equalizing an air temperature in said test chamber.

### BRIEF DESCRIPTION OF THE DRAWINGS

Further objects, features and advantages of the invention will appear from the following detailed description, from the attached drawings as well as from the dependent claims. The invention will be described in further detail below, reference being made to the accompanying drawings, in which:

FIG. 1 is a schematic side view of a climatic test chamber system according to an embodiment of the invention;

FIG. 2 is a schematic side view of a climatic test chamber system according to an alternate embodiment of the invention;

FIG. 3 is a schematic view illustrating a climatic test chamber system according to the embodiment of the invention, wherein the different components of each unit are shown;

FIG. 4 is a flow chart illustrating a method of providing a climatic test according to the invention; and

FIG. 5 is a schematic view illustrating another embodiment of the system of the invention.

### DETAILED DESCRIPTION OF AN EMBODIMENT

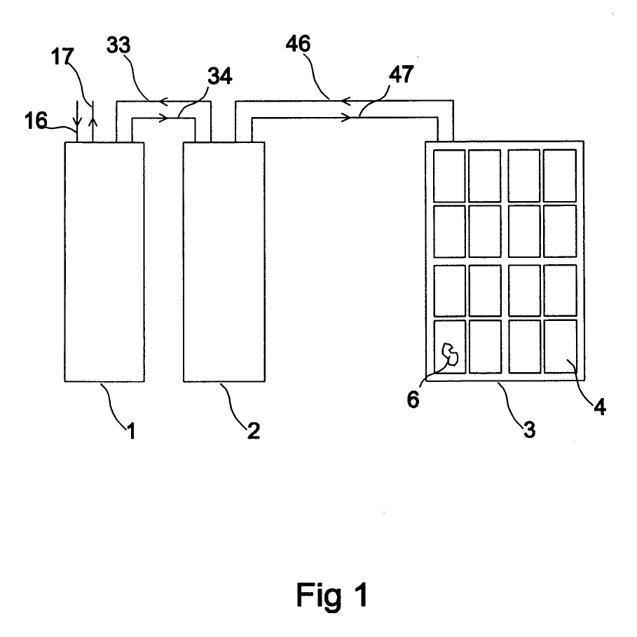

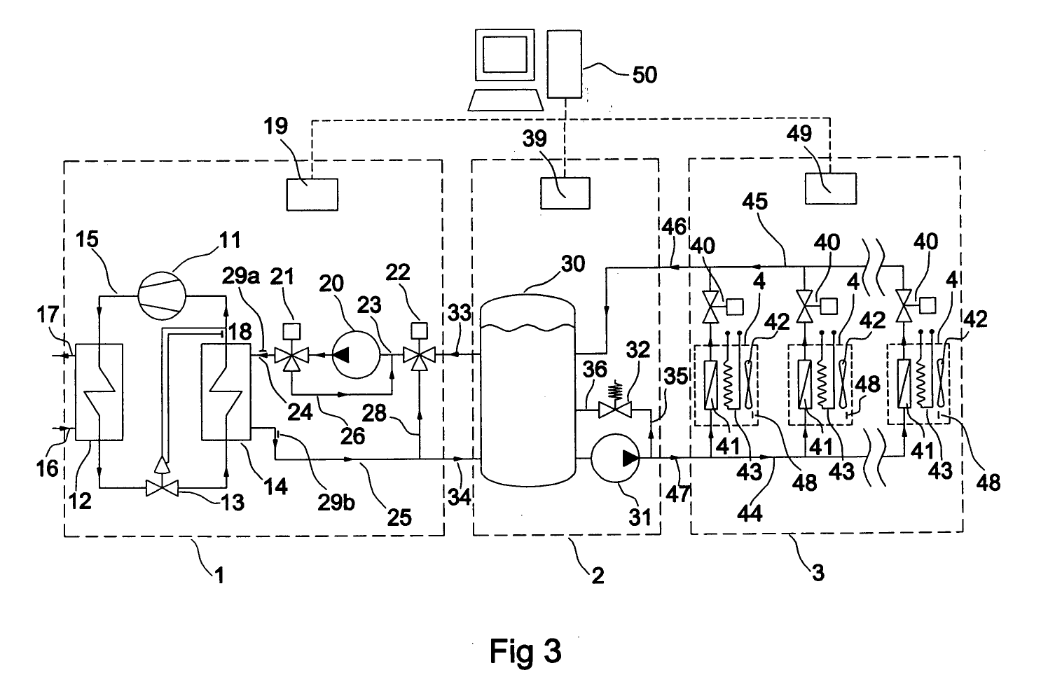

A climatic test chamber system substantially according to the invention is schematically shown in FIG. 1. The system includes a first part 1 comprising a cooling unit and a circulation unit; a second part 2 comprising a tank unit and a feeding unit; and a chamber unit 3 having a plurality of test chambers 4. The components of each unit are shown in more detail in FIG. 3.

The cooling unit comprises conventional refrigerating means, such as a compressor 11, a condenser 12, an expansion valve 13 and an evaporator 14, for cooling a primary refrigerant circulating in a cooling circuit 15 connecting said means. The primary refrigerant, which is a fluid, is compressed, for example to about 10-20 Bar, in the compressor 11, thus being transferred from a gas to a liquid (condensing process) when passing through the condenser 12, hence being cooled. The primary refrigerant is thereafter allowed to evaporate and becomes once again a gas with a pressure of about −0.5 to 0.5 Bar, after passing the expansion valve 13. The expansion valve 13 is regulated by different parameters, e.g. temperature and pressure. Those parameters are checked at an outlet 18 of the evaporator 14, as illustrated in FIG. 3, for optimal use of the evaporator 14. This procedure is well known to a skilled person and standard components are used. The gaseous primary refrigerant absorbs energy from a secondary refrigerant, which will be described below, when it passes through the evaporator 14, wherein the secondary refrigerant is cooled. Water, such as tap water, is used for cooling the primary refrigerant by entering an inlet 16 and passing through the condenser 12 to an outlet 17.

The primary refrigerant may be R404A, for example SUVA HP62 from DuPont, a standard fluid that is less environmentally harmful than other fluids normally used for refrigeration purposes.

The condenser 12 may be a plate heat exchanger, for example a brazed heat exchanger from SWEP, Sweden, or a welded heat exchanger from Vatherus, Finland.

The expansion valve 13 regulates the cooling circuit 15. The compressor 11 will however automatically be switched off by controlling means (not shown) when pressure or temperature limits are reached. The refrigerating capability of the circuit depends on the properties of the primary refrigerant as well as the choice of compressor, condenser and evaporator, respectively.

To summarize, the function of the above-described cooling unit, comprising the compressor 11, the condenser 12, the expansion valve 13 and the evaporator 14, is to extract heat energy from the secondary refrigerant by a mechanical refrigerating process.

Alternatively to the cooling unit described above, any type of cooling unit may be used, such as a Peltier element generating cold from electricity.

The circulation unit includes a circulation pump 20 for circulating the liquid, secondary refrigerant through a line 24, passing a second control valve 21, through the evaporator 14, and further through a line 25 to a tank inlet 34 of the tank unit 2 and to be stored in a tank 30 when the secondary refrigerant is of a set desired temperature, as explained in more detail below.

An adjustable flow pump may replace the circulation pump 20, whereby the second control valve 21 may be removed. The secondary refrigerant leaves energy to the primary refrigerant when passing through the evaporator 14 and is thus cooled.

The refrigerating capacity of the evaporator 14 depends on both the flow rate of the secondary refrigerant through the heat exchanger and the temperature difference between the two sides of the evaporator 14, i.e. between the primary and secondary refrigerant. The second control valve 21 regulates the flow of the secondary refrigerant; any excess flow will be bypassed back to the circulation pump 20 through a line 26 and a line 23.

A temperature monitoring means 29b is mounted at the outlet of the evaporator 14 and is adapted to check the temperature of the cooled secondary refrigerant versus a set point temperature, before transfer to the tank 30 for storing or accumulation. If the secondary refrigerant is not sufficiently cooled, i.e. does not achieve or is above the set point temperature (desired temperature), it will be fed back to the evaporator 14 through a line 28.

A first control valve 22 regulates the mixing ratio of the secondary refrigerant from the line 28 and the tank outlet line 33 respectively, in order to obtain a desired temperature of the secondary refrigerant before it enters the tank 30.

When starting the cooling process of the secondary refrigerant, the control valve 22 is first closed so that no exchange of refrigerant to and from the tank 30 will occur, and also to avoid disturbance of the temperature distribution in the tank 30 described below. The circulation pump 20 has a relatively large flow, about 1-2 liters/sec, to create a turbulent flow over the surface of the evaporator 14. If the flow is too small, there is a risk of getting a partly laminar flow, which can result in a poor cooling performance of the evaporator 14. When the temperature has reached the desired set temperature, which may be about −50 to −40° C. and which is controlled by the temperature monitoring means 29b, the control valve 22 starts to adjust and warm secondary refrigerant is taken out from the top of the tank and cold refrigerant is delivered to the bottom of the tank. A certain volume of refrigerant is continuously taken from the top 33 of the tank 30, typically 10-30% of the flow of the circulation pump 20 (about 0.10 to 0.65 liters/sec), and the same volume is returned to the bottom 34 of the tank 30. The volume taken out is controlled to be so small that the temperature of the secondary refrigerant introduced into the bottom of the tank is never above a specific low temperature, such as −40° C. In this way, a buffer of cold secondary refrigerant is built up in the bottom of the tank. Due to the fact that the secondary refrigerant has a higher specific weight at a lower temperature, the secondary refrigerant will form stratification in the tank with the coldest refrigerant at the bottom and warmer refrigerant at the top. The temperature difference, or gradient, can be substantial. However, if a high flow rate is present into and out of the tank, the stratification may be disturbed.

The object is to maintain a low temperature at the bottom of the tank, close to the inlet temperature of for example −40° C.

A PLC (programmable logic circuit) or a microprocessor 19, mounted inside the unit, may regulate the total circulation.

The secondary refrigerant in the tank 30 has a temperature gradient, the lowest temperature being at the bottom and the highest temperature at the top of the tank 30, the above-mentioned expression “temperature distribution” is related to this gradient. The reason for the existing gradient is that cooled secondary refrigerant is transferred from the cooling unit 1 to the tank 30 by the bottom inlet of the tank, whereas used secondary refrigerant from the chamber unit 3, which has a higher temperature than the refrigerant at the bottom inlet, is transferred back to the the top of the tank 30, as will be described below. An important feature is that the tank may have a temperature difference of up to about 120° C. As an example the temperature may be about −50 to −40° C. at the bottom of the tank 30 and is up to +70° C. at the top thereof. The cooled secondary refrigerant is accumulated in the tank 30 to be used instantly or later in only one or in several test chambers simultaneously and individually.

The tank unit 2 further comprises a circulation pump 31 for transferring the cooled secondary refrigerant from the bottom of the tank 30 to the chamber unit 3 through a line 47. The circulation pump 31 gives a constant flow or constant pressure of secondary refrigerant, and is activated as soon as at least one test chamber 4 is in use and when cooling is needed. The circulating pump 31 has the capability to simultaneously serve every test chamber 4. When only a minor amount of secondary refrigerant is required, a control valve 32 will be activated to unload the pump 31 by passing the excess of secondary refrigerant back to the tank 30 through lines 35 and 36. An adjustable flow pump may replace the pump 31, hence eliminating the control valve 32. The control valve may be a constant pressure valve that maintains a constant pressure between the outlet and inlet of the pump.

The chamber unit 3 is provided with a plurality of individual test chambers 4, such as 4-16, which are isolated from each other and the environment with foam of polyurethane. Each test chamber has a double steel shell forming an interspace having a heat exchanger 41, a fan 42 and a resistive heating element 43 arranged therein. A door with hinges is mounted at the front of the shell to make it possible to insert a test item into the test chamber 4.

Temperature monitoring means 48 are provided in each test chamber 4 and are connected to a controller 49, such as a PLC (programmable logical circuit), for controlling the components of the chamber unit 3. The controller 49 is coupled to an external control device 50, for example a microprocessor or a PC, for setting set point temperatures (desired temperatures) and duration times. The external control device 50 is also connected to the cooling unit, by the controller 19, for controlling and regulating the operation of the entire procedure.

After insertion of a test item into an individual test chamber 4, and setting the set point temperature and test durations by means of the control device 50, several steps will follow in order to perform the climatic test.

The cooled secondary refrigerant, stored in the tank 30, is transferred by means of the circulation pump 31 through the line 47 to the chamber unit 3, and further through lines 43 and 47 to the heat exchanger 41 in the test chamber 4. It passes through the heat exchanger 41, thus cooling the air in the test chamber 4, the flow rate being regulated by a control valve 40, and flows through lines 45 and 46 back to the top of the tank 30. The resistive heating element 43 is electrically actuated, if the temperature in the test chamber 4 is lower than the set point temperature; if it is higher, additional refrigerant is transferred to the test chamber 4, until the temperature of the test chamber has achieved the set point temperature. The fan 42 ensures an uniform temperature of the air in the entire test chamber 4, and is activated as soon as a test starts.

Heat is never difficult to achieve, but it may be difficult to rapidly get a cold environment. Advantageously, the tank unit according to the invention makes this possible.

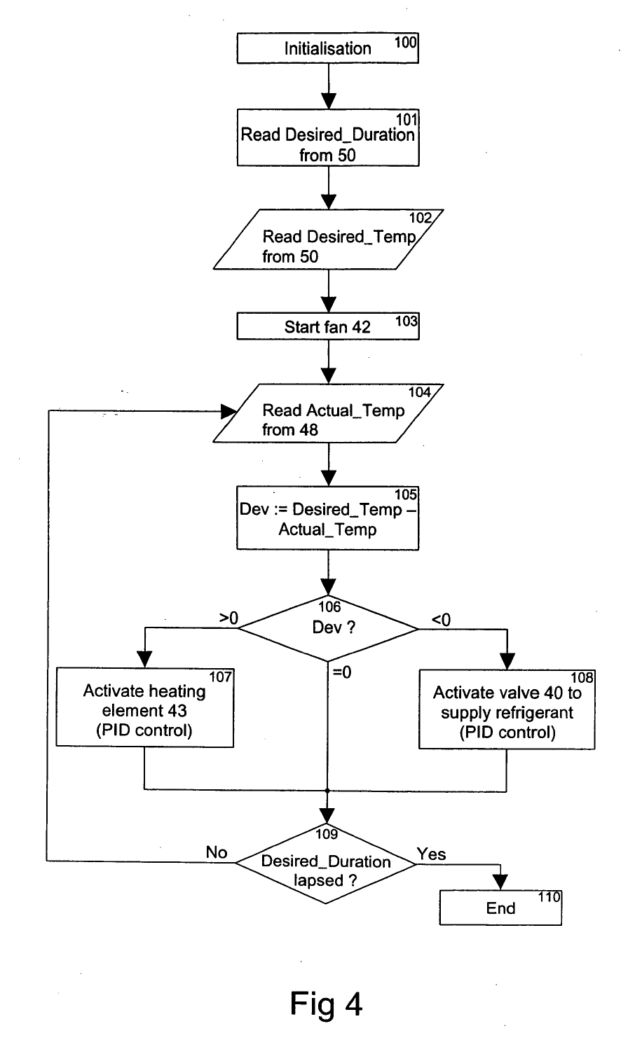

Different steps of the flow chart in FIG. 4 illustrate the procedure of a climatic test in one test chamber 4. Before the test starts, it is assumed that the user has selected desired temperatures and duration times by means of the external PC 50. In the embodiment, the procedure is implemented by software stored and executed by the controller 49. In a first step 100 internal registers, memories, etc. are initialized. In a second step 101 a Desired_Duration variable is read from the PC 50. In a third step 102 a Desired_Temp variable is read from the PC 50. The fan 42 is activated in a step 103 to get a uniform temperature in the test chamber 4. In a step 104 the actual temperature Actual_Temp in the test chamber 4 is read from the temperature monitoring means 48. The read actual temperature Actual_Temp is compared with the selected desired temperature Desired_Temp in a step 105. In a step 106 a decision is made regarding the next step depending on if the deviation Dev between Desired_Temp and Actual_Temp is zero, has a positive value or has a negative value. If the deviation is zero, i.e. the actual temperature is equal to the desired one, a step 109 follows, wherein the desired duration time Desired_Duration is checked. If it has lapsed, the test is finished in a step 109, otherwise it continues and the next step will be 104 once again. If the deviation Dev has a positive value, the actual temperature is lower than the desired one, and consequently the resistive heating element 43 is electrically actuated in a step 107 to reach the desired temperature. If the deviation Dev has a negative value, the actual temperature is higher than the desired one, and consequently the control valve 40 is activated in a step 108 to supply cooled secondary refrigerant to the heat exchanger 41, hence cooling the air in the test chamber 4. In step 107 and 108 the regulation is performed according to a PID control algorithm, which is well known per se. The desired duration time Desired_Duration will be checked in a step 109 after the steps 107 and 108, respectively. If the time has lapsed, the test will end in a step 110; otherwise the next step will be 104 once again.

The above-disclosed procedure relating to one test chamber 4 is applicable to any test chamber 4 in the climatic test chamber system according to the invention.

The physical properties of the secondary refrigerant are of importance regarding the lowest, achievable temperature of the air in the test chambers. By choosing a suitable fluid, e.g. an alcohol, or alternatively a brine, test temperatures from −40° C. to +200° C. may be obtained.

To summarize, the present invention provides a system that is capable of simultaneously performing multiple individual tests in several chambers in a controlled way. The temperature, as well as the entire operation of the system, is regulated by different means to obtain and maintain the control thereof.

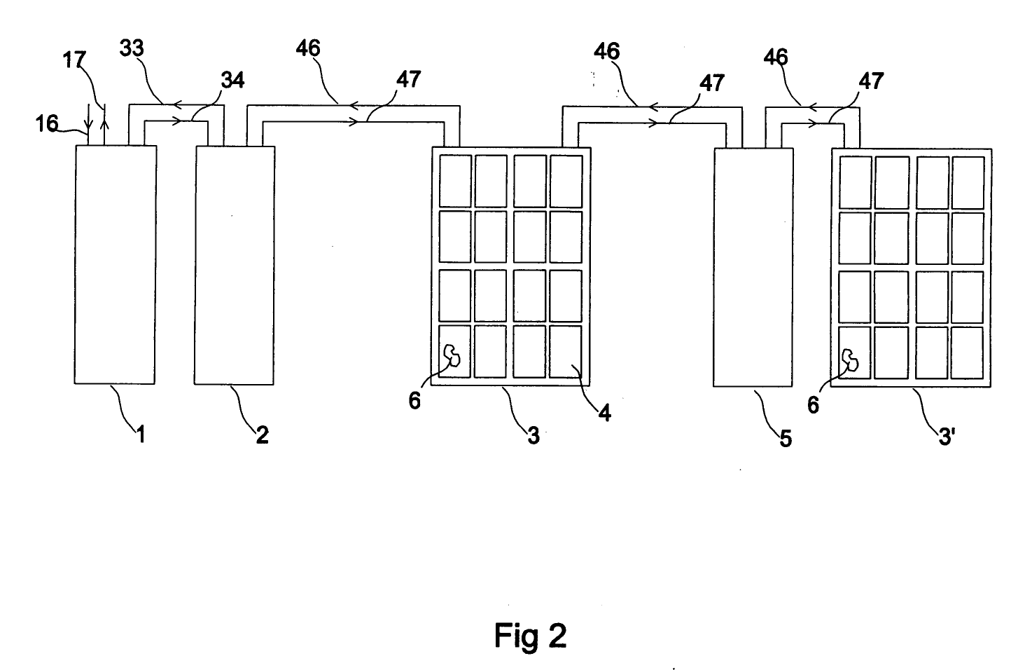

An alternate embodiment of the invention is shown in FIG. 2. To get a scalable and customer adapted system, it is possible according to the invention to connect at least one additional cooling unit and circulation unit 5, respectively, and/or at least one additional tank unit, and/or at least one additional chamber unit 3′ to said system. This might be done if units of equal type are adjacently connected to each other, and the units are using the same inlets 17, 34, 47 and outlets 16, 33, 46, respectively, as shown in FIG. 2. The compressor of each cooling unit may be of different capacity, the tank units may differ in size, and the individual test chambers 4 within the same unit 3 or 3′ may also differ in size to get more flexibility.

The cooling unit and the tank unit can be placed adjacently to or separately from the test chamber unit 3. Arrangement of all the units in close proximity to each other gives a straight installation. It is possible to keep the noise at a low level by using a compressor of Scroll type, also giving high capability and a long lifetime. The noise level in the test room can be minimized if the cooling unit and the tank unit are placed separately from the test chamber unit 3, for example in another room or outdoors, hence keeping the room temperature of the test room at a decent level.

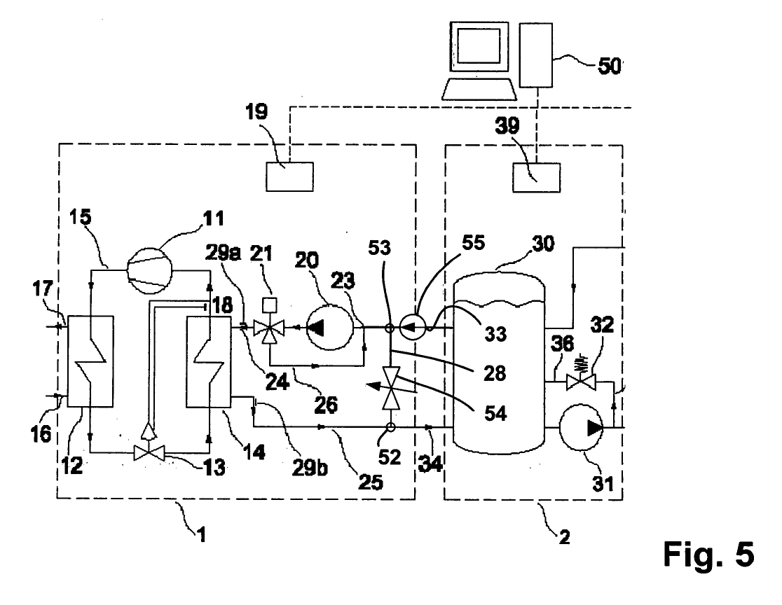

A further embodiment of the invention is shown in FIG. 5, in which the same reference numbers have been used for the same components as appears from FIG. 3. The cooling unit comprises a first circulation circuit 15 comprising an evaporator 14, a line 25 up to a point 52, a line 28 up to a point 53, a pump 20 and a valve 21. The second refrigerant circulates in this first circuit 51. The speed of flow is controlled by pump 20 in combination with the valve 21 shunting the flow via line 26. The speed is maintained so that turbulent flow is prevailing in the cooling member or evaporator 14. The temperature sensor 29b senses the output temperature and when the temperature is sufficiently low, the speed of the pump 20 is decreased or the shunt flow is increased, resulting in a slower flow through evaporator 14. A further temperature sensor 29a senses the input temperature of the evaporator and aids in determining suitable flow in the first circulation circuit.

When a low temperature has been established in the first circuit, a restriction unit, such as an adjustable valve 54 arranged in line 28, is operated to generate a pressure differential between points 52 and 53. This will result in a flow from the top of the tank 30 via line 33 to the point 53, introducing warm secondary refrigerant to the first circuit. A corresponding amount of cold fluid is taken out from the first circuit at point 52 and introduced to the bottom of tank 30 via line 34. Alternatively, or in addition, a pump 55 may be operated to transfer secondary refrigerant via line 33 to point 53. The pump 55 and/or the adjustable valve 54 are controlled by the system so that the temperature of the output from evaporator 14, as measured by temperature sensor 29b, does not rise above a predetermined temperature. All the time, the circulation is present in the first circuit, to efficiently use the evaporator and maintain the secondary refrigerant in this circuit below said temperature.

It is understood that the pump 55 may as well be arranged in line 34 instead of in line 33. The tank is arranged so that a positive pressure always exists at the top outlet of the tank 30 to line 33 so that no air can enter the system.

The flow out of and into the tank 30 is so small that no substantial equalization of the temperature in tank 30 is obtained and the above-mentioned stratification is achieved. The tank 30 is constructed with a sufficient cross-sectional area to ensure substantially no mixing.

Herein above has been described several embodiments of the invention with reference to the drawings. However, the different features shown at the drawings may be combined differently than explicitly shown and such combinations are intended to be within the scope of the invention, which is only limited by the appended patent claims.

1. A climatic test chamber system comprising:
a tank unit comprising a tank for accumulating a secondary refrigerant at a low temperature at the bottom of the tank;
a cooling unit for cooling said secondary refrigerant to at least said low temperature;
a circulation unit for circulating said secondary refrigerant from an upper part of said tank, through said cooling unit and to a lower part of said tank;
a chamber unit comprising several test chambers for housing objects to be tested, each test chamber having isolation means for heat isolation of each test chamber mutually and separately;
a feeding unit for providing secondary refrigerant from said tank to each of said test chambers individually at demand.

2. The system of claim 1, said cooling unit comprising:
a cooling member maintained at a low temperature and having an inlet and an outlet;
a first circulation circuit comprising:
a pump having an inlet and an outlet;
a first line for connecting the outlet of the pump to the inlet of the cooling member;
a second line for connecting the outlet of the cooling member to the inlet of the pump a second circulation circuit comprising:
a third line for connecting an inlet of the lower part of the tank to said first circulation circuit at a first connection point;
a fourth line for connecting an outlet of the upper part of the tank to said first circulation circuit in a second connection point, which is arranged downstream in relation to said first connection point in said first circulation circuit.

3. The system of claim 2, wherein said cooling unit comprises a third circulation circuit comprising a compressor, an expansion valve, a condenser, an evaporator, and a primary refrigerant circulating in said circuit, wherein said cooling member is said evaporator.

4. The system of claim 2, wherein said pump is controlled by a temperature sensor arranged adjacent the outlet of said cooling member.

5. The system of claim 4, further comprising a shunt valve arranged between the outlet and the inlet of the pump for shunting a variable portion of the flow of the pump in dependency of said temperature sensor, for maintaining the secondary refrigerant at the outlet of the cooling member at or below a predetermined temperature.

6. The system of claim 2, further comprising:
a restriction unit arranged in said first circulation circuit between said first and second connection point for generating a pressure for driving the secondary refrigerant in said second circulation circuit.

7. The system of claim 6, wherein said restriction unit is a three-way valve arranged to pass a portion of the secondary refrigerant from said first circulation circuit and a portion of said secondary refrigerant from said second circulation circuit, the ratio between said portions being adjustable by said valve.

8. The system of claim 2, further comprising a pump arranged in said second circulation circuit, said pump being adjustable.

9. The system of claim 2, wherein the circulation in said second circulation circuit is controllable so that the secondary refrigerant entering said lower part of said tank has a temperature, which is equal to or lower than a predetermined temperature.

10. The system of claim 2, each test chamber further comprising:
a heat exchanger for receiving secondary refrigerant by said feeding unit;
a control valve for controlling the flow of secondary refrigerant through said heat exchanger to obtain a desired temperature of said test chamber.

11. The system of claim 10, each test chamber further comprising:
a heating element, such as a resistive heating element, and
a fan for equalizing an air temperature in said test chamber.

12. The system of claim 10, said feeding unit further comprising:
a feeding unit having a pump for feeding said secondary refrigerant from an outlet adjacent the bottom of said tank to each of said heat exchanger of each of said test chambers, said secondary refrigerant being returned to the tank at an inlet thereof adjacent the top of the tank.

13. The system of claim 12, wherein said feeding unit comprises a shunt valve arranged between an outlet and an inlet of the pump.

14. The system of claim 2, wherein said the tank comprises a temperature gradient from the bottom to the top of the tank.

15. The system of claim 2, wherein the secondary refrigerant is selected from the group comprising:
alcohol, brine and oil.

16. A method of operating a test chamber system, comprising:
circulating a secondary refrigerant from a top portion of a tank, through a cooling unit and to a bottom portion of said tank for accumulating cold secondary refrigerant at the bottom portion of said tank;
circulating said secondary refrigerant from the bottom of said tank to each of at least two test chambers individually at demand, said test chambers housing objects to be tested.

17. The method of claim 16, further comprising:
circulating said secondary refrigerant through a first circulation circuit comprising:
a pump having an inlet and an outlet;
a first line for connecting the outlet of the pump to the inlet of the cooling member;
a second line for connecting the outlet of the cooling member to the inlet of the pump;
circulating said secondary refrigerant through a second circulation circuit comprising:
a third line for connecting an inlet of the lower part of the tank to said first circulation circuit at a first connection point;
a fourth line for connecting an outlet adjacent the top of the tank to said first circulation circuit in a second connection point, which is arranged downstream in relation to said first connection point in said first circulation circuit.

18. The method of claim 17, further comprising:
circulating a primary refrigerant in a third circulation circuit comprising a compressor, an expansion valve, a condenser, an evaporator, wherein said cooling member is said evaporator.

19. The method of claim 18, wherein said circulation in said first circulation circuit is variable by means of a shunt circuit for shunting a variable portion of a constant flow from the outlet of the pump to the inlet of the pump.

20. The method of claim 19, further comprising:
feeding said secondary refrigerant from the bottom portion of the tank to a heat exchanger of each test chamber to obtain a desired temperature of said test chamber.
